(19) United States
(12) Patent Application Publication
(10) Pub. No.: US 2007/0261898 A1
(43) Pub. Date: Nov. 15, 2007

(54) Traction Assembly for Vehicles and Components Therefor

(76) Inventor: Robert Bessette, Mont St-Gregoire (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/626,193

(22) Filed: Jan. 23, 2007

(30) Foreign Application Priority Data
Jan. 24, 2006 (CA) 2,533,851

(51) Int. Cl. B62D 55/00

(52) U.S. Cl. 180/9.21

(57) ABSTRACT

This invention generally relates to traction assemblies for use as wheel replacements generally for heavy and/or large vehicles and also to components therefor. The traction assembly generally comprises a sprocket wheel adapted to be mounted to one of the axles of the vehicle, a frame adapted to be pivotally mounted to the vehicle, idlers wheels mounted at the fore and at the aft of the frame and road wheels mounted therebetween and a traction band mounted around the sprocket wheel, the idlers wheels and the road wheels and cooperating therewith for propulsion.

### CROSS-REFERENCE TO RELATED APPLICATIONS

The present application claims the benefits of commonly assigned Canadian Patent Application No. 2,533,851, filed on Jan. 24, 2005.

### FIELD OF THE INVENTION

This invention generally relates to traction assemblies for vehicles and to certain components therefor. Without being limitative in nature, the present invention particularly relates to traction assemblies used a wheel replacements for heavy vehicles (i.e. vehicles weighing 5000 kg or more) such as, but not limited to, heavy machineries, agricultural equipments, construction equipments and forestry equipments.

### BACKGROUND OF THE INVENTION

The type of surfaces over which a vehicle is ridden significantly affects its capacity and efficiency.

While the riding behavior is one of the most important aspects involved in the conception of most vehicles, the ability to allow interchangeability of parts or to retrofit new components on existing vehicles generally greatly satisfies the owner of vehicles and represents an interesting market source for vendors of specialized parts destined to vehicles such as All-Terrain Vehicles (hereinafter “ATV”), light trucks, jeeps, etc.

It is known in the art that vehicles with wheels are sometimes inappropriate for riding over certain types of terrain which are muddy, soft, sandy, snow-covered or the like. The wheels of such vehicles generally tend to sink into the ground when used over terrains as described above.

In order to enhance the capabilities of wheel-equipped vehicles over such terrains, numerous types of wheel replacing traction assemblies have been proposed throughout the years. These assemblies generally involve the replacement of the wheels connected to the drive train of the vehicle with assemblies generally comprising a sprocket wheel, a support structure or frame, idler and/or road wheels and a traction band mounted therearound.

The traction band used in these assemblies generally has a larger contact area with the ground. Therefore, the weight of the vehicle is spread over a much larger area, thereby diminishing the pressure applied to the ground surface. When the ground surface is soft such a snow or mud, the vehicle equipped with these traction assemblies will have a lesser tendency to sink and the general traction of the vehicle will be enhanced accordingly.

Different types of traction assemblies have been proposed to replace the wheels of almost every kind of wheeled vehicles. Nowadays, traction assemblies exist to replace the wheels of ATVs, light trucks and jeeps, agricultural and farming equipments and other heavy machinery.

Still, the particular design of a traction assembly for use on small vehicles such as ATV or light truck can rarely be applied to a traction assembly for use on farming equipments and/or other similar heavy and/or large vehicles. The weight of the vehicle and the strain applied to the traction assembly when in use are substantially different according to the type of vehicle onto which the assembly is installed.

Different types of traction assemblies for heavy machineries exist in the art. See for example “Converter Assembly for Converting a Drive-Wheel Tractor into a Track-Driven Tractor” (U.S. Pat. No. 5,240,084, granted to Peter J. Christianson), “Tracklaying Vehicles” (U.S. Pat. No. 5,273,126, granted to John N. Reed et al.), “Endless Belt Traction Device for Vehicles” (U.S. Pat. No. 5,388,656, granted to Richard Lagasse), “Articulated Vehicle” (U.S. Pat. No. 6,116,362, granted to William Schubert et al.), “Working Vehicle with Semicrawlers” (U.S. Pat. No. 6,199,646, granted to Yushifumi Tani et al.) and “Triangular Crawler Apparatus” (U.S. Pat. No. 6,283,562, granted to Haruhiro Tsubota et al.).

One of the main problems with these traction assemblies is that the support structure that supports the idler wheels and/or the road wheels is made of a single piece. Since these assemblies are generally large pieces of equipment, the support structure comprises therein is generally also a large and generally long piece. Hence, when the traction assembly has to follow the curvature of the terrain, all the support structure must move, thereby implying large and often uncomfortable and unpleasant movements for the driver. Traction assemblies having suspension systems or lower pivotal point exist but they only partially prevent large movements of the support structure.

There is therefore a need for a traction assembly and certain components therefor which generally improve the riding condition of the vehicle and which also preferably obviate other shortcomings present in prior art traction assemblies.

### SUMMARY OF THE INVENTION

The present invention generally involves a traction assembly that can preferably replace a wheel on a vehicle. The present invention thus involves a vehicle having a frame and at least one traction axle. Preferably, the traction assembly of the present invention can replace wheels on either side of the front portion and/or the rear portion of the vehicle.

More particularly, the traction assembly of the present invention generally comprises a sprocket wheel adapted to be fixedly mounted to the axle of the vehicle, generally via the wheel hub, a support structure, also mounted to the vehicle, which generally supports idler wheels at each of its extremities and preferably a plurality of road wheels in-between, and a longitudinally extending traction band mounted around the sprocket wheel, the idler wheels and the road wheels and drivingly cooperating therewith.

According to one aspect of the present invention, the support structure preferably comprises two sub-structures or portions and at least two but preferably three pivot points. The support structure is generally adapted to be mounted to the frame of the vehicle, preferably near the traction axle where the sprocket wheel is attached, via a first pivot point and a second pivot point. These first and second pivot points are generally fixed. In other words, their distance with respect to the axis of the axle never changes when the vehicle is in use. The two sub-structures or portions are also preferably pivotally connected together via a third pivot point. The pivots are preferably located at a height lower than the height of the rotation axis of the sprocket wheel. In an embodiment of the present invention, the first pivot point is preferably generally longitudinally displaced in relation with the axis of the sprocket wheel and preferably toward the front on the vehicle whereas the second pivot point is preferably generally longitudinally displaced in relation with the axis of the sprocket wheel and preferably toward the rear of the vehicle. Also in this embodiment, the third pivot point is preferably generally located under the axis of the sprocket wheel. This particular arrangement generally allows the support structure to follow the curvature of the terrain independently of the sprocket wheel.

According to another aspect of the present invention, the support structure preferably supports, at each of its extremities, at least one but preferably a plurality of idler wheels which keep the traction band tensioned. The support structure also supports a plurality of road wheels to support the traction band and prevent it from detracking. Since the present traction assembly is preferably installed on farming tractors, agricultural vehicles, forestry equipments and other similar heavy machines, it may be necessary to install wide traction band on the assembly. Therefore, in order to provide adequate support for the traction band, it might be necessary for the traction assembly to support a plurality of idler and/or road wheels in a widthwise or parallel arrangement. Accordingly, the idler and/or road wheels are preferably mounted onto wheel axle assembly wherein the bearing assemblies are not in contact with the exterior environment.

According to yet another aspect of the present invention, the structure or one of the sub-structures preferably comprises a tensioning system coupled to the axle assembly supporting the front or rear set of idler wheels. The tensioning system allows longitudinal displacements of the axle assembly which correspondingly increase or decrease the tension in the traction band.

According to another aspect of the invention, the idler and/or road wheel axles are preferably secured to the support structure with locking devices. The locking devices provide an easier way to mount and/or dismount the wheel axles independently from each other. Accordingly, an entire row of wheels can be easily removed for repairing or maintenance without dismounting the whole support structure.

In another aspect of the invention, the support structure is preferably provided with devices adapted reduce and preferably prevent the accumulation of debris (e.g. soil, dirt, gravel, snow, mud, rock) at the periphery of the idler and/or road wheels while the vehicle is moving. The devices, preferably fixedly mounted to the support structure, are also preferably provided with at least one and preferably a plurality of members or brackets extending therefrom between adjacent idler or road wheels in order to reduce and preferably prevent the accumulation of debris therebetween.

The features of the present invention which are believed to be novel are set forth with particularity in the appended claims.

### BRIEF DESCRIPTION OF THE FIGURES

The above and other objects, features and advantages of the invention will become more readily apparent from the following description, reference being made to the accompanying drawings in which:

FIG. 1 is a perspective view of the a first embodiment of the traction assembly of the present invention as installed on a vehicle.

FIG. 2 is a side view of the traction assembly of FIG. 1 as installed on a vehicle.

FIG. 3 is perspective view of the traction assembly of FIG. 1 as installed on a vehicle.

FIG. 4 is side view of the sprocket wheel according to the present invention.

FIG. 5 is a perspective exterior view of the traction assembly of FIG. 1 in the closed position and without the band.

FIG. 6 is a perspective exterior view of the traction assembly of FIG. 1 in the opened position and without the band.

FIG. 7 is an exterior side view of the traction assembly of FIG. 1 in the closed position and without the band.

FIG. 8 is an exterior side view of the traction assembly of FIG. 1 in the opened position and without the band.

FIG. 9 is a perspective interior view of the traction assembly of FIG. 1 in the closed position and without the band.

FIG. 10 is a perspective interior view of the traction assembly of FIG. 1 in the opened position and without the band.

FIG. 11 is an interior side view of the traction assembly of FIG. 1 in the closed position and without the band.

FIG. 12 is an interior side view of the traction assembly of FIG. 1 in the opened position and without the band.

FIG. 13 is an exterior perspective view of the traction assembly of FIG. 1 in the closed position and without the band.

FIG. 14 is an exterior side view of the tensioning system according to an embodiment of the present invention.

FIG. 15 is an interior side view of the tensioning system of FIG. 14.

FIG. 16 is a bottom view of the a second embodiment of the traction assembly of the present invention.

FIG. 17 is a top view of the traction assembly of FIG. 16, without the sprocket wheel.

FIG. 18 is a cross-sectional side view of the traction assembly of FIG. 16, without the sprocket wheel.

FIG. 19 is a cross-sectional perspective view of the traction assembly of FIG. 16, without the sprocket wheel.

FIG. 20 is a fragmentary perspective view of the axle receiving portion of the support structure of the traction assembly of the present invention and of the axle during a first step of the installation.

FIG. 21 is a fragmentary perspective view of the axle receiving portion of the support structure of the traction assembly of the present invention and of the axle during a second step of the installation.

FIG. 22 is a fragmentary perspective view of the axle receiving portion of the support structure of the traction assembly of the present invention and of the axle during a third step of the installation.

FIG. 23 is a fragmentary perspective view of the axle receiving portion of the support structure of the traction assembly of the present invention and of the axle during a fourth step of the installation.

FIG. 24 is a fragmentary perspective view of the axle receiving portion of the support structure of the traction assembly of the present invention and of the axle during a fifth step of the installation.

FIG. 25 is a partial cross-sectional perspective view of the idler wheels mounted on an axle assembly.

FIG. 26 is an exploded perspective view of the idler wheels and the axle assembly.

### DETAILED DESCRIPTION OF THE PREFERRED EMBODIMENTS

A novel traction assembly for vehicles and certain components therefor will be described hereinafter. Although the invention is described in terms of specific illustrative embodiments, it is to be understood that the embodiments described herein are by way of example only and that the scope of the invention is not intended to be limited thereby.

As a preliminary note, as used hereinabove and hereinafter, the term “elastomeric” generally relates to any elastic and primarily non metallic materials such as natural and/or synthetic rubber, elastomers, polymers and/or combinations thereof used in the manufacture of endless tracks.

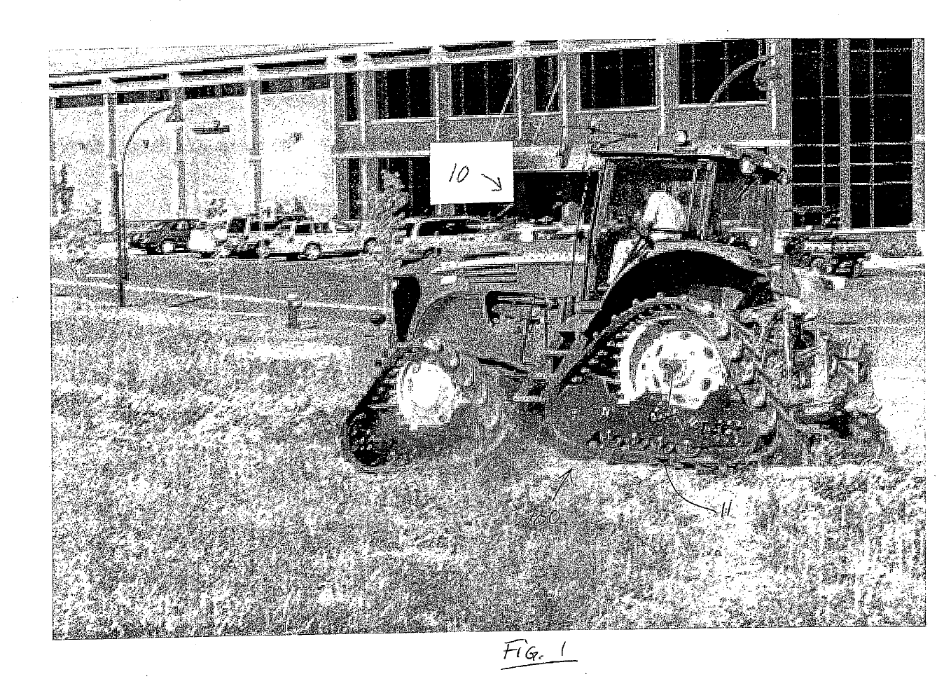

Referring to FIG. 1, there is shown a first embodiment of the traction assembly 100 as installed on the rear axle 11 of a farming tractor 10.

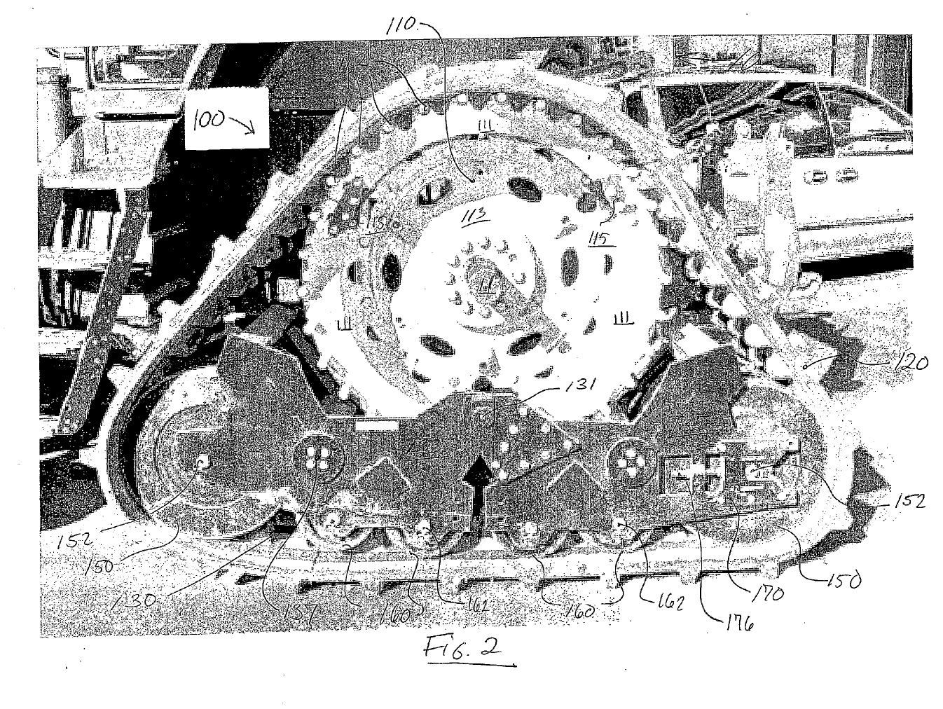

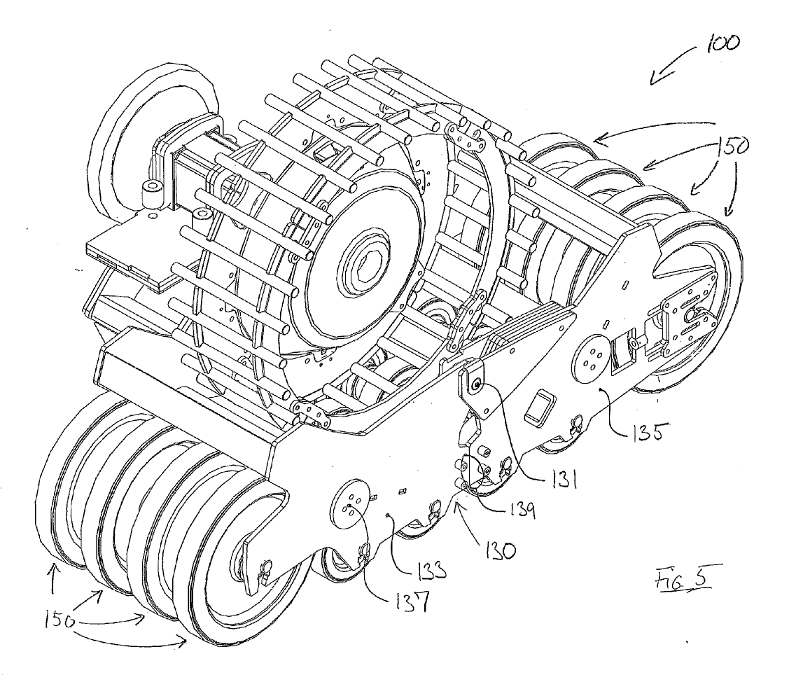

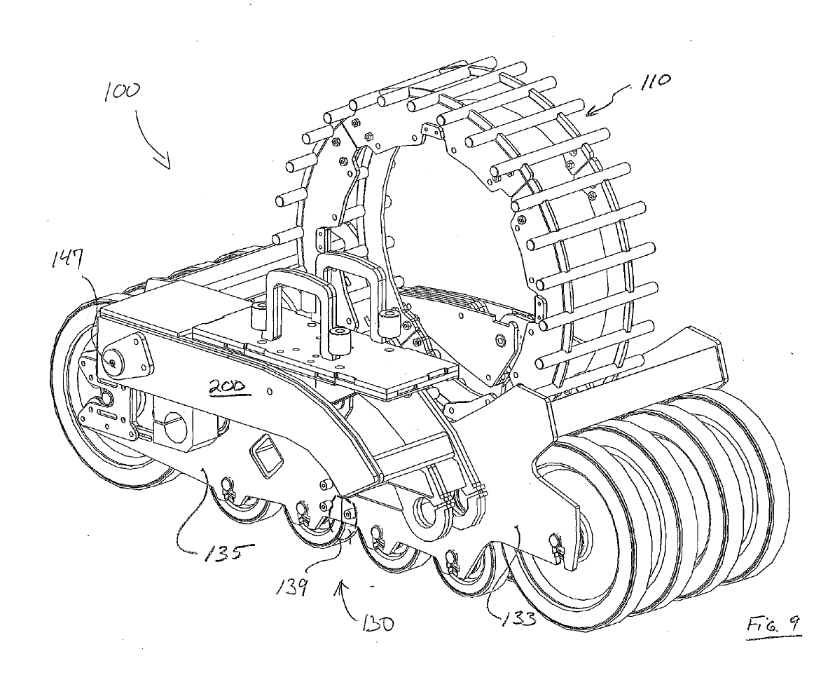

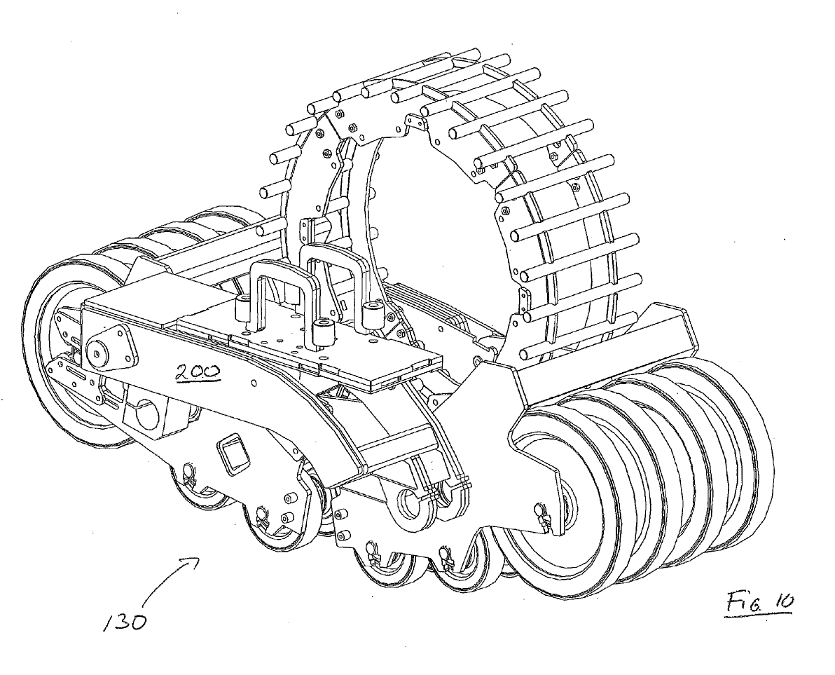

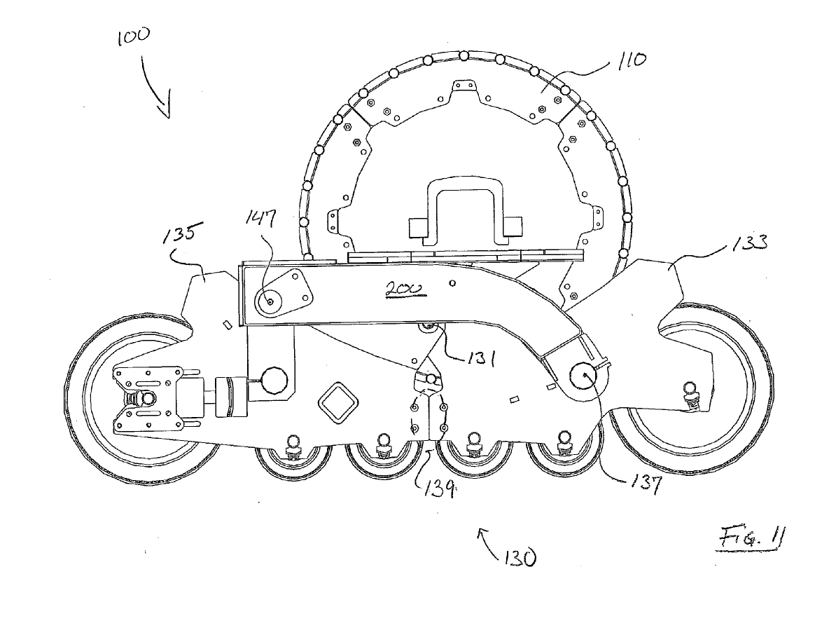

FIG. 2 presents in more details the main components of the traction assembly 100. The assembly 100 comprises a sprocket wheel 110 adapted to be mounted onto the axle 11 (or wheel hub) of a vehicle 10. In FIG. 2, the vehicle 10 is a farming tractor. However, the traction assembly 100 can replace the wheels of other heavy wheeled vehicles without departing from the scope of the invention. The sprocket wheel 110 comprises a plurality of generally evenly spaced sprocket teeth 112 located at the periphery thereof. The sprocket teeth 112 drivingly engages a traction band 120 which is also tensioned around a front and rear rows 151 of idlers wheels 150 and a plurality of road wheels 160. The idler wheels 150 and the road wheels 160 are pivotally mounted onto a support structure 130 via idler wheel axle 152 and road wheel axle 162 respectively. In a first embodiment of the present invention, the support structure 130 comprises a first pivot point 137 and a second pivot point 147 (see FIG. 9) which pivotally connect the support structure 130 to the frame of the vehicle 10 via a bracket assembly 200 (see FIGS. 5-6 and 9-12). This first pivot point 137 is preferably located under the axis of the axle 11 and longitudinally displaced with respect to the axis of the axle 11. Similarly, the second pivot point 147 is preferably located under the axis of the axle 11 and longitudinally displaced with respect to the axis of the axle 11. In the embodiment shown in FIG. 2, the first pivot point 137 is located on the front portion 133 of the support structure 130 and the second pivot point 147 is located of the rear portion 135 of the support structure 130. In this first embodiment, the support structure 130 further comprises a third pivot point 131 which pivotally links the generally front portion 133 and the generally rear portion 135 of the structure 130. The rear portion 135 further comprises a tensioning system 170 described in more details below.

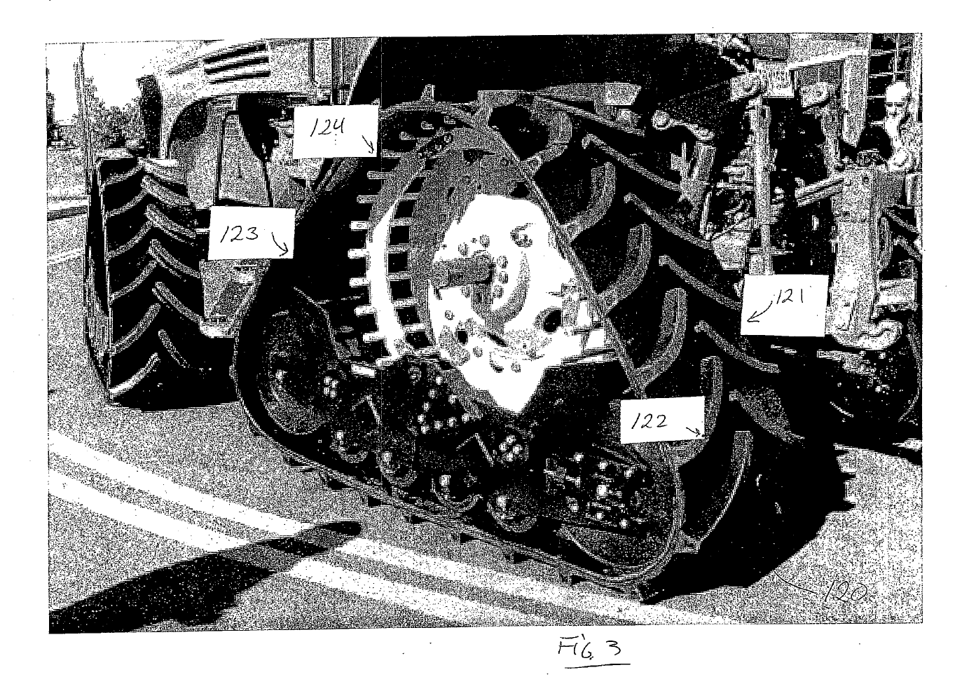

The traction band 120, shown in FIG. 3, is preferably made of elastomeric materials. The traction band 120 is also preferably, but not exclusively, made as a single endless band. The traction band 120 generally comprises a ground-engaging outer surface 121 and a sprocket engaging inner surface 123. The outer surface has a tread pattern which consists of a plurality of outwardly projecting traction lugs 122. The particular design and arrangement of the traction lugs 122 are chosen according to the terrain over which the vehicle is ridden. As for the inner surface 123, it generally comprises a least one and preferably a plurality of rows of longitudinally aligned sprocket-engaging driving lugs 124. The driving lugs 124 are adapted to be drivingly engaged by the teeth 112 of the sprocket wheel 110.

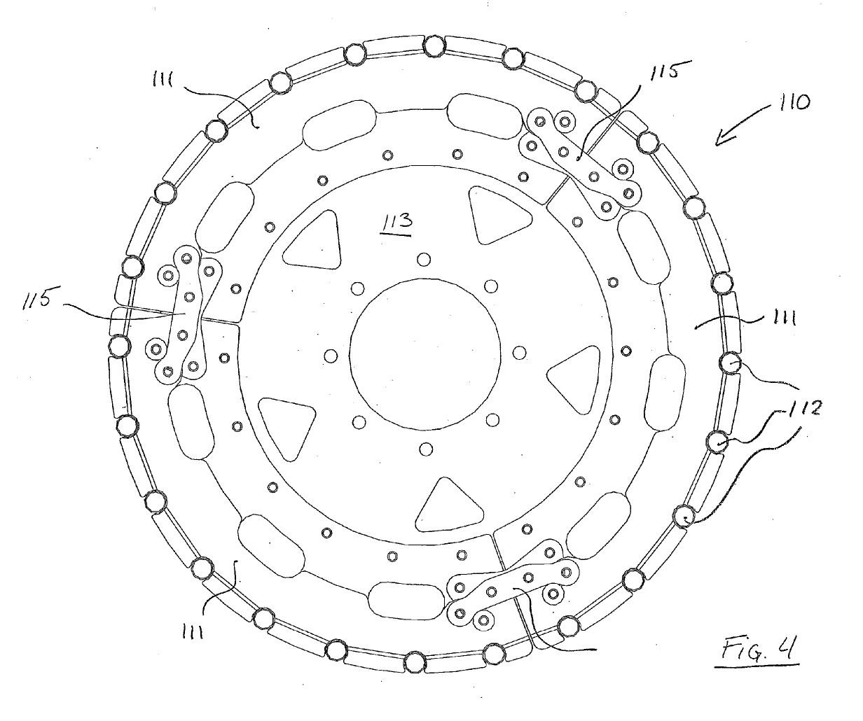

As shown in more details in FIG. 4, it can be seen that the sprocket wheel 110 is in fact composed of three peripheral sprocket portions 111 and a central sprocket portion 113. The reason for this multiple pieces sprocket 110 construction is the weight. Should the sprocket wheel 110 be made of a single piece of metal, the weight of the wheel 110 would be excessive and the installation and uninstallation procedures would be correspondingly harder.

The central or core portion 113 is generally adapted to be mounted on the axle 11 (or wheel hub, not shown) of the vehicle 10. The central portion 113 is mounted to the axle 11 (or wheel hub) with mounting means known in the art (e.g. bolt and nut assemblies).

The portions 111 are mounted at the periphery of the central portion 113 using nut and bolt assemblies. Consecutive peripheral portions 111 are further secured together via attaching plate 115 and nuts and bolts assemblies.

The skilled addressee will understand that a traction assembly 100 for use on a smaller vehicle 10 could use a single piece sprocket wheel 110. In fact, the present invention contemplates the use of single piece and multiple pieces sprocket wheel 110. Therefore, the choice between a single piece sprocket wheel 110 and a multiple pieces sprocket wheel 110 depends upon the size of the traction assembly 100 and the desired ease of manipulation of the wheel 110.

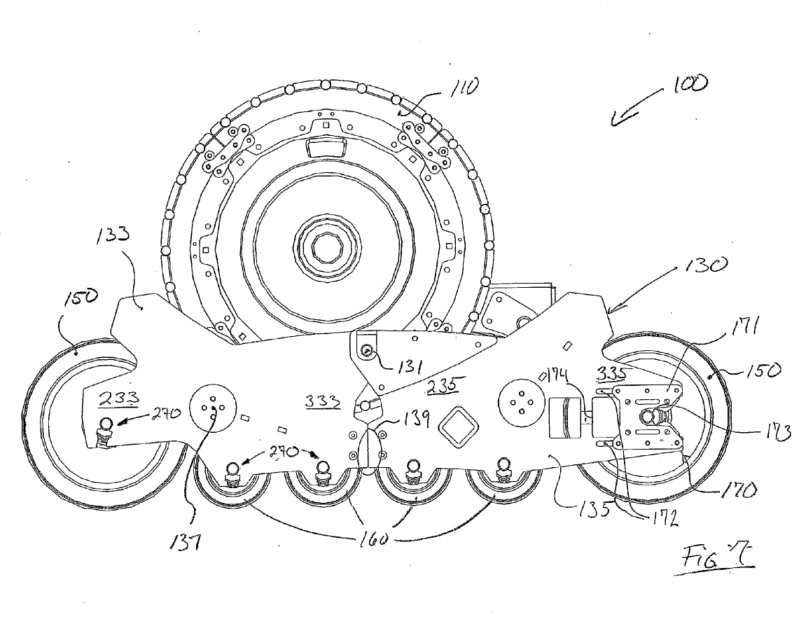

Now referring to FIGS. 5-13, the support structure 130 of a first embodiment of the present traction assembly 100 is shown in more details.

In FIGS. 5, 7, 9 and 11, we can see the traction assembly 100 in its normal closed position. When the traction assembly 100 is in closed position, front portion 133 and rear portion 135 are in contact or in near contact around contact point 139. The closed position is the normal position when the traction assembly 100 is driven over a generally flat surface.

With prior art assemblies, when a traction assembly faces a bump or a depression, all the support structure has to move even though only the front of the structure is in contact with the bump (or depression). For small traction assembly, this movement of the support structure may be relatively small but for larger traction assembly, the support structure being a generally large member, the amplitude of the movement could be quite large. This, in turn, generally translates into abrupt movements which can be uncomfortable for the driver.

Since the traction assembly 100 of the present invention in made of two pivotally connected portions 133 and 135, the movement of the support structure is correspondingly less abrupt.

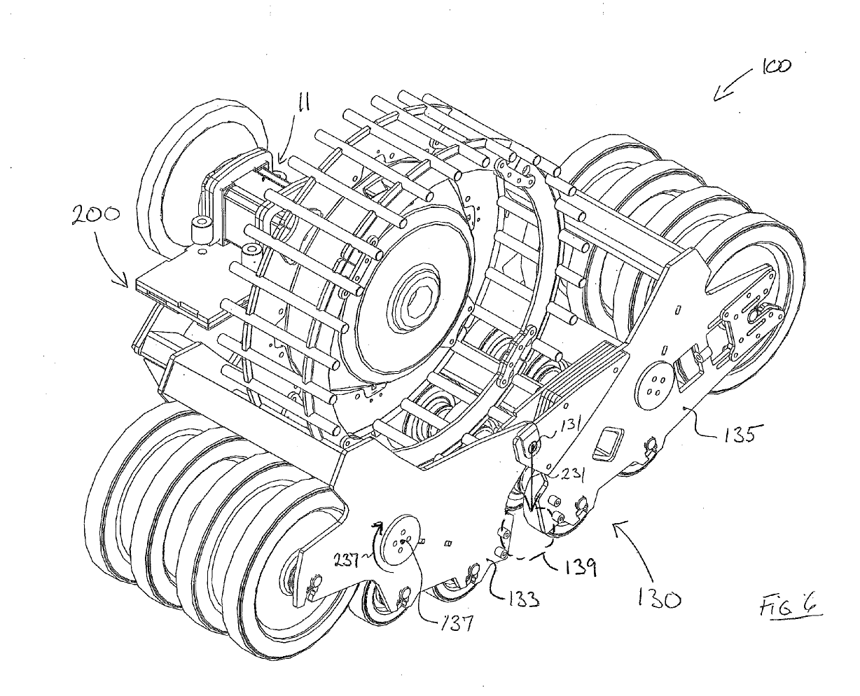

Now referring to FIGS. 6, 8, 10 and 12, when the traction assembly 100 faces a bump, the front portion 133 of the structure 130 will pivot around pivot point 137 in the direction generally indicated by the arcuate arrow 237. In other words, the forward section 233 of the front portion 133 will raise whereas the rearward section 333 will descend.

In its descending movement, the rearward section 333 will drag along the pivot point 131 which pivotally connects the front portion 133 to the rear portion 135. The downward movement of the pivot point 131 is generally indicated by the arrow 231.

Since the front portion 133 and the rear portion 135 are pivotally connected by the pivot point 131, when the pivot point 131 descends with the rearward section 333, it forces the forward section 235 of the rear portion 135 in a similar downward motion. This downward motion of the forward section 235 will induce, in reaction, a counter pivotal motion of the rear portion 135 around the second pivot point 147. The direction of this pivotal motion is generally indicated by arrow 247. This pivotal motion 247 will then induce an upward movement of the rearward section 335. The support structure therefore opens in the area 139 where the two portions 133 and 135 initially contacted each other.

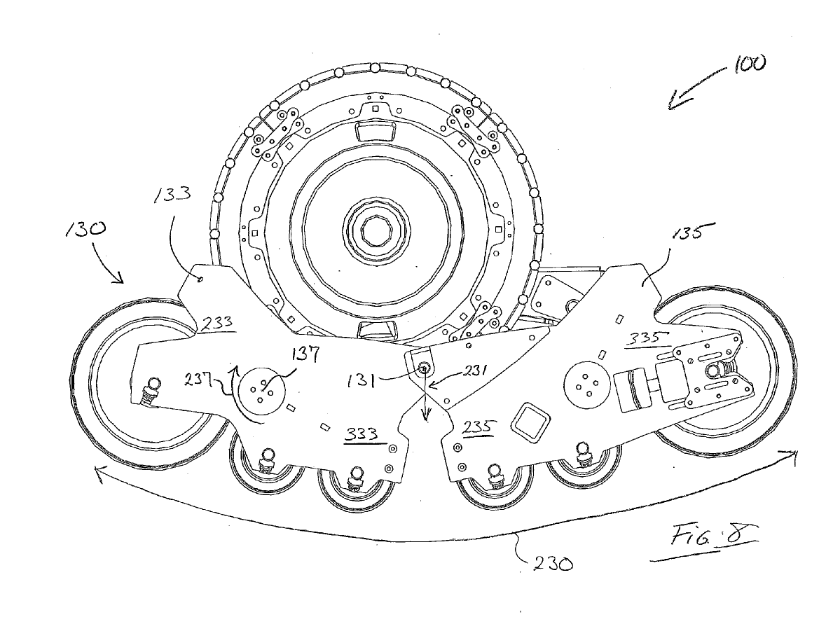

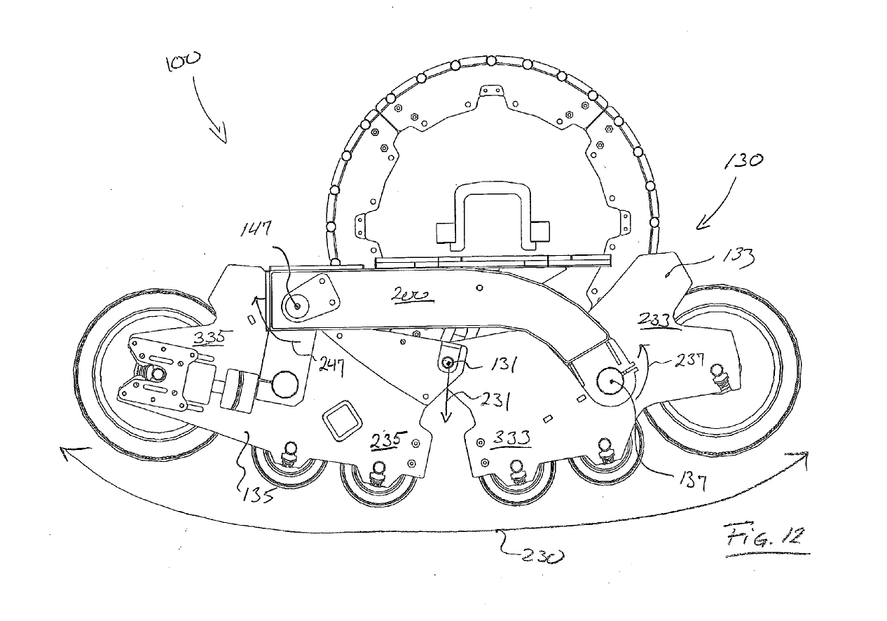

As clearly shown in FIGS. 8 and 12, when the support structure is in open position, the skilled addressee will note that the support structure 130 defines a generally curved shape indicated by the curved arrow 230. This curved shape allows to better follow the curvature of the terrain without inducing abrupt movements in the traction assembly and ultimately, in the vehicle.

When the traction assembly returns on a generally flat surface, the support structure will generally return to its closed position.

The skilled addressee will understand that the traction assembly 100 could be mounted in reverse wherein the pivot point 137 is located on the rear portion 135 and the pivot point 147 is located on the front portion 133. The principles of the operation would stay the same albeit inverted.

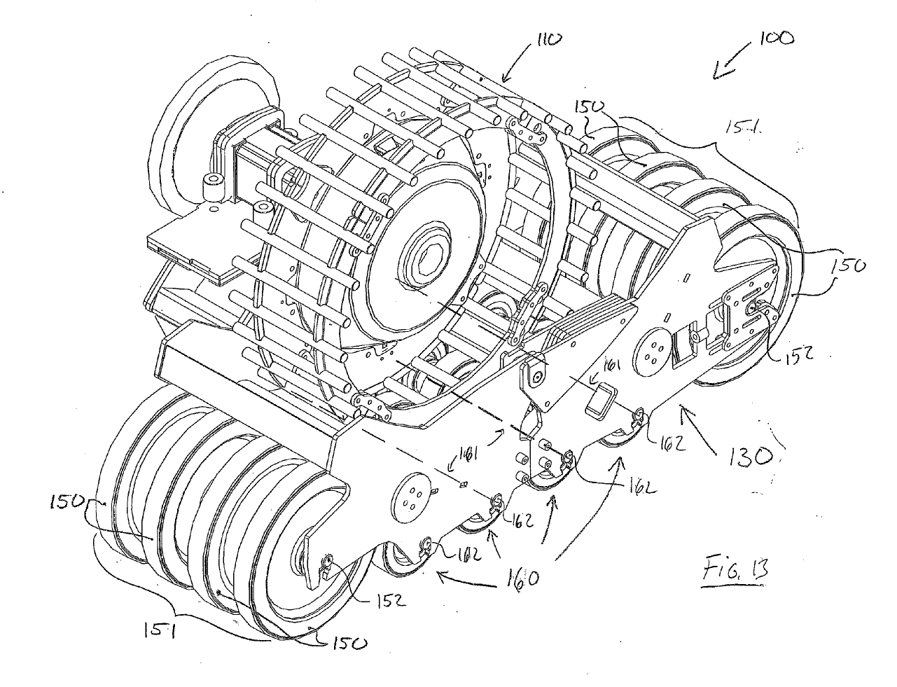

As best seen in FIG. 13, the support structure 130 generally supports a plurality of road wheels 160 which are pivotally mounted thereto. In the preferred embodiment of the present invention, the road wheels 160 are mounted in multiple rows 161, each row 161 comprising several road wheels 160 generally coaxially mounted onto an axle assembly 260. This widthwise distribution of road wheels 160 in each row 161 generates a better and more uniform support for the traction band 120. However, the number of rows 161 and the number of road wheels 160 in each row 161 are generally chosen according to the size of the traction assembly 100 and the size of the traction band 120 though other criteria could be also considered.

In a similar fashion, each of the forward section 233 of the front portion 133 and the rearward section 335 of the rear portion 135 supports a row 151 of idler wheels 150. As for the road wheels 160, the idler wheels 150 are generally coaxially mounted on an axle assembly 250. This widthwise distribution of the idler wheels 150 in each row 151 generates a better and more uniform support for the traction band and also helps to prevent detracking of the band 120.

The road wheels 160 and the idler wheels 150 located on a given axle assembly 260 and 250 respectively are generally laterally and evenly spaced apart to allow the passage of the drive lugs 123 between two adjacent road or idler wheels 160 or 150. The space between two adjacent wheels 150 or 160 is thus determined by the width of the drive lugs 123.

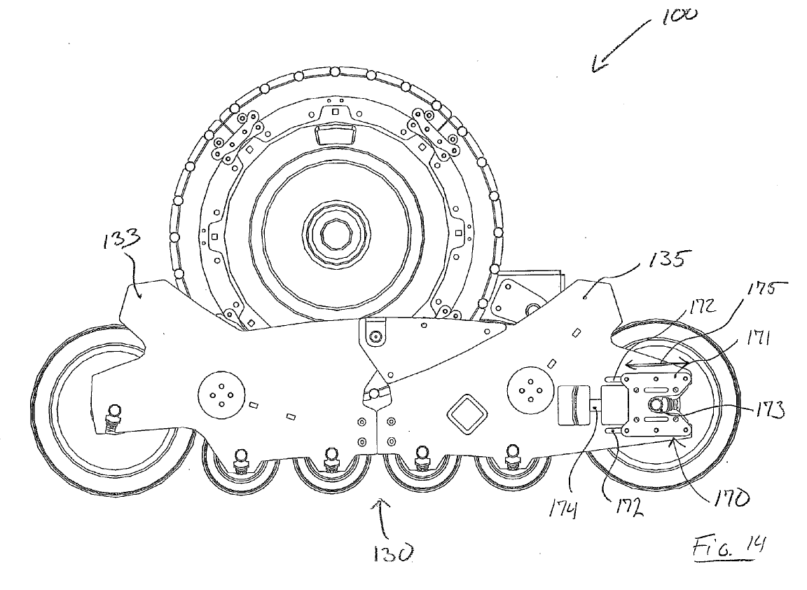

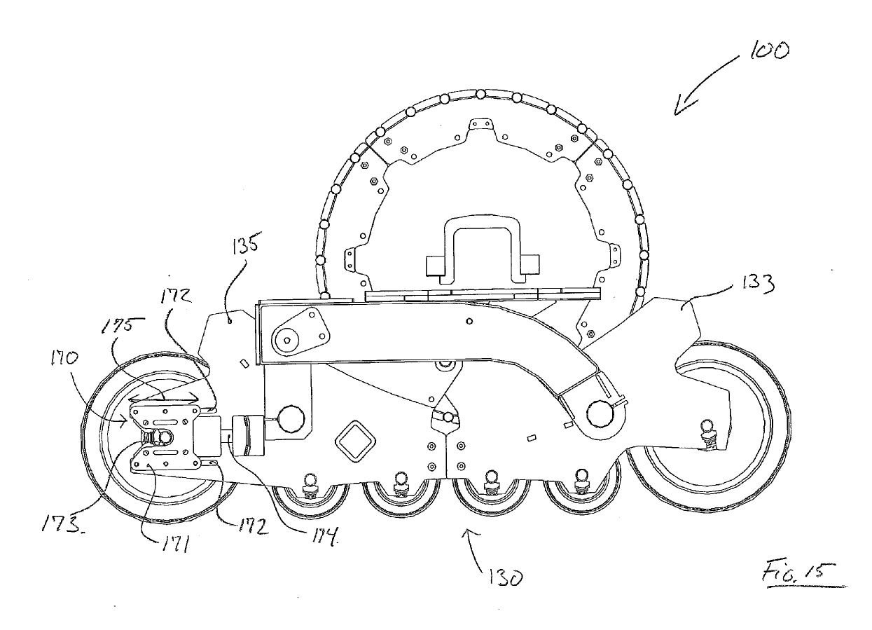

Now referring to FIGS. 14 and 15, the rear portion 135 of the support structure 130 further comprises a tensioning assembly 170. The tensioning assembly 170 comprises a pair of plates 171, one located on each side of the support structure 130, which are slidingly mounted into grooves 172 on the rearward section 335 of the rear portion 135 and held in place with nuts and bolts assemblies (not shown). Each plate 171 comprises a generally U-shaped receiving area 173 adapted to receive the axle 152 of the axle assembly 250 of the idler wheels 150. The tensioning assembly 170 further comprises a pair of push-bolts 176 (shown in FIG. 2), one on each side of the support structure, threadedly mounted onto a threaded bracket 174 located on the rear portion 135 of the support structure 130 and generally abutting on the plate 171. By screwing (or unscrewing) the push-bolts, it is possible to push (or retract) the plates 171, effectively pushing (or retracting) the idler wheels 150 and therefore tensioning (or relaxing) the traction band 120. Arrow 175 shows the general possible motions of the tensioning assembly when the push-bolt are actuated.

As the skilled addressee would understand, the tensioning assembly 170 could alternatively be installed or provided on the forward portion 233 of the front portion 133 of the support structure 130.

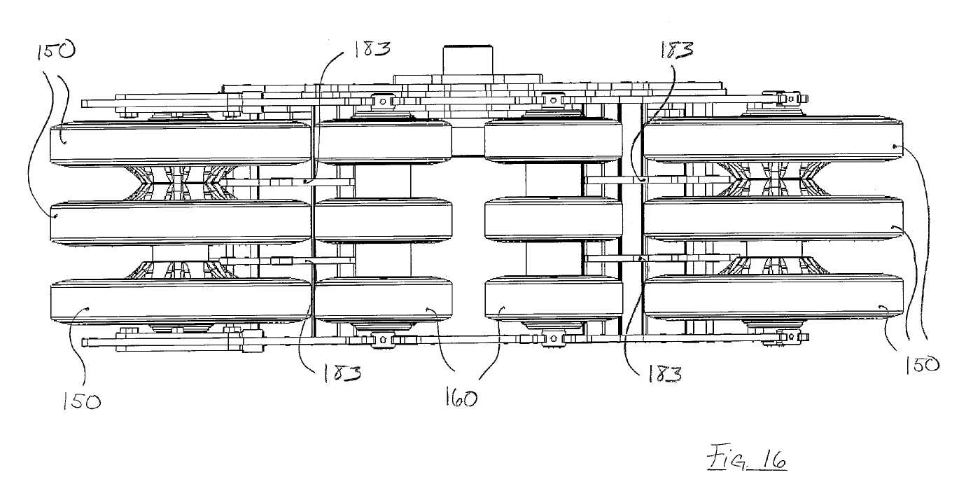

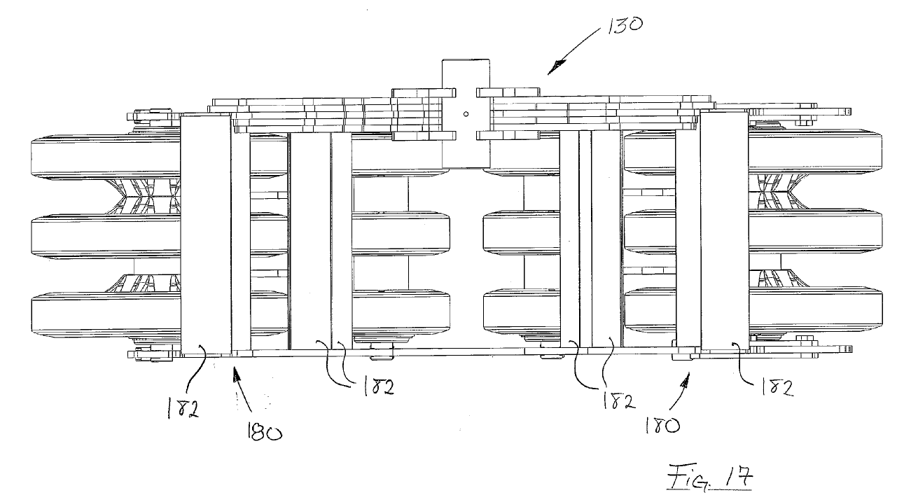

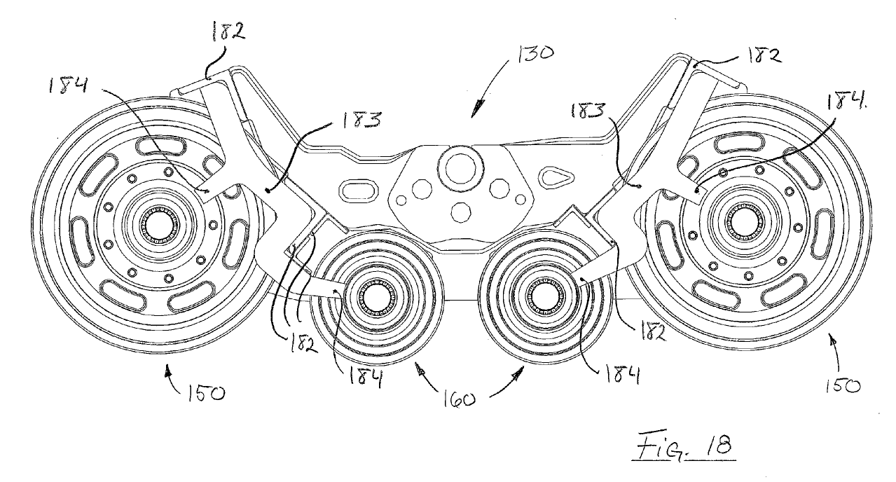

Referring now to FIGS. 16 to 19, another embodiment of the present invention is shown. In this second embodiment, the support structure 130 is unitary though the skilled addressee would understand that it could readily be provided with pivotally mounted front portion 133 and rear potion 135 as in FIGS. 1 to 15. The present invention is therefore not so limited.

As mentioned above, the idler wheels 150 and the road wheels 160 are laterally spaced apart to allow the passage of the drive lugs 124 of the traction band 120. However, by having idler wheels 150 and road wheels 160 so configured, debris (e.g. rock, gravel, sand, mud, snow, ice and the like) are likely to accumulate in the space defined between them and possibly, at the periphery of the idler wheels 150 and of the road wheels 160.

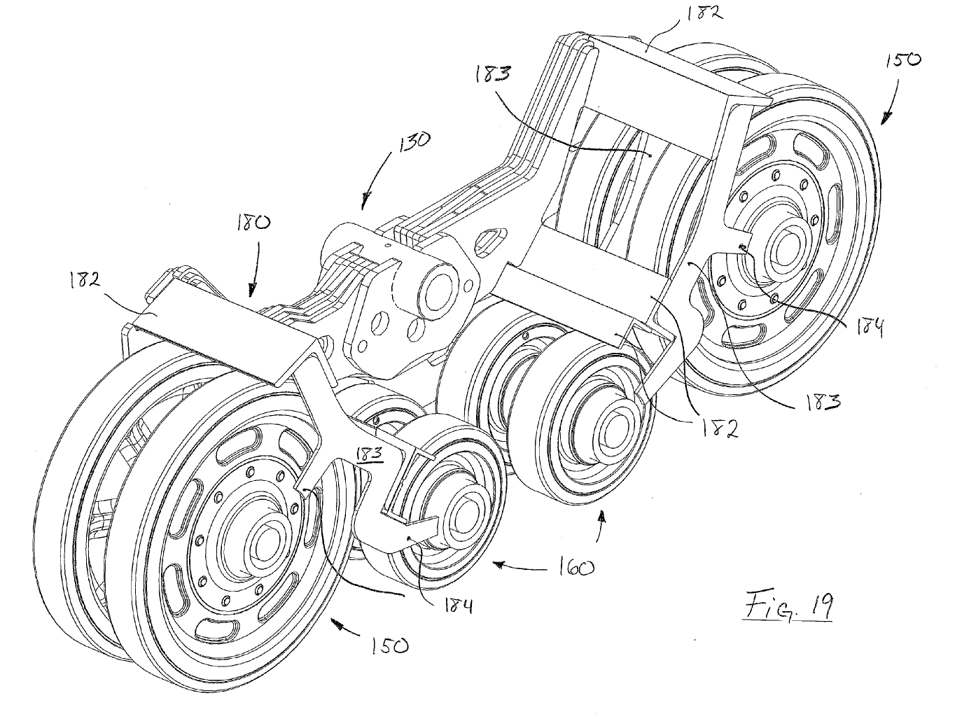

In order to prevent or at least reduce such accumulation and as best shown in FIG. 19, the second embodiment of the present invention is provided with devices 180 to reduce and preferably prevent the accumulation of such debris at the periphery of the idler wheels 150 and of the road wheels 160 and also preferably between them.

As shown in FIGS. 16 to 19, the devices 180 comprise one or more laterally extending members or beams 182, generally fixedly mounted to the structure 130, usually but not exclusively by welding. The members 182 are generally provided in the shape of iron angle though other shapes could be used to obtain similar results. As shown in the figures, the members 182 are preferably positioned near or adjacent the outer periphery of the idler wheels 150 and the road wheels 160 in order to block or scrape debris that might be present thereon. Still, a gap is generally left between the members 182 and the wheels to prevent accidental contact between them.

In order to also reduce and prevent the accumulation of debris in the space between laterally adjacent wheels, the devices 180 are preferably further provided with brackets 183 which are themselves formed with outwardly extending fingers 184. The fingers 184 generally extend in the space between laterally adjacent wheels and toward the outer tube 154 or 164 of the axle assembly 250 or 260 in order to block or scrape debris that could be present on the axle assembly and/or in the space between the wheels. Still, as for the members 182, as gap is left between the fingers 184 and the axle assemblies to prevent accidental contact.

In the embodiment of FIGS. 16 to 19, one finger 184 preferably extends between each pair of adjacent wheels. Understandably and as shown in the figures, a plurality of fingers 184 can extend from a single bracket 183, the invention is not so limited. Moreover, though preferably mounted to the members 182, the brackets 183 could alternatively be directly mounted to the structure 130 of the traction assembly.

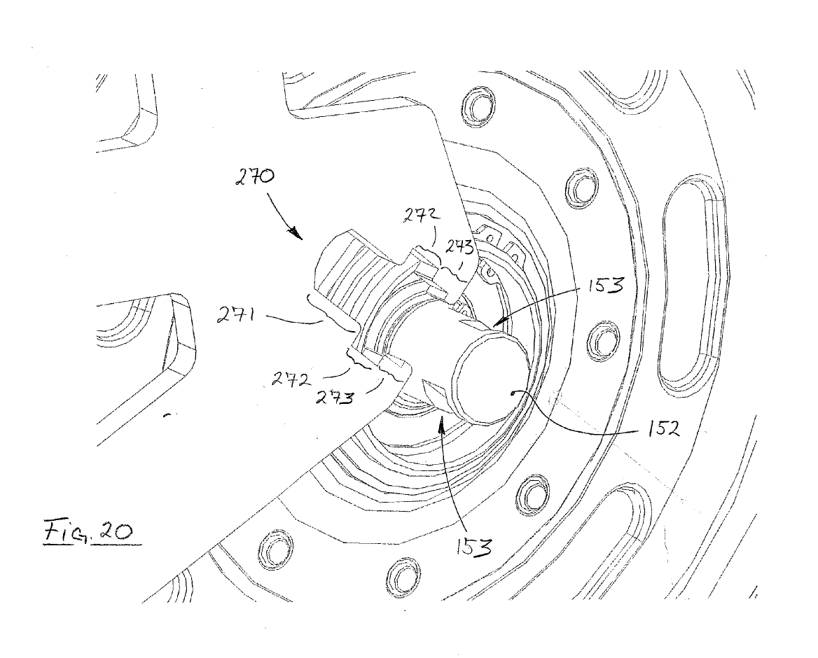

Now referring to FIGS. 20 to 24, the different steps to mount and lock the axle 152 (or 162) of the axle assembly 250 (or 260) into the axle receiving areas 270 of the support structure 130 are shown. As shown in FIG. 20, the receiving area 270 generally comprises a U-shaped axle receiving portion 271, opposite channel portions 272 and opposite shoulder portions 273.

In the first step, shown in FIG. 20, the axle 152 of the axle assembly 250 is generally inserted into the U-shaped portion 271 of the receiving area 270 of the support structure 130 via grooves 153 provided at the lateral extremities of the axle 152. The grooves 153 of the axle 152 and the U-shaped portion 271 are preferably complementary in order to provide a secure arrangement therebetween and to prevent unwanted movements.

In order to prevent the axle 152 from accidentally exiting the receiving area 270 of the support structure 130, the axle 152 is preferably locked in place via locking element 190 and locking screw 195. The locking element 190 is generally provided with a threaded aperture 191 for receiving the locking screw 195.

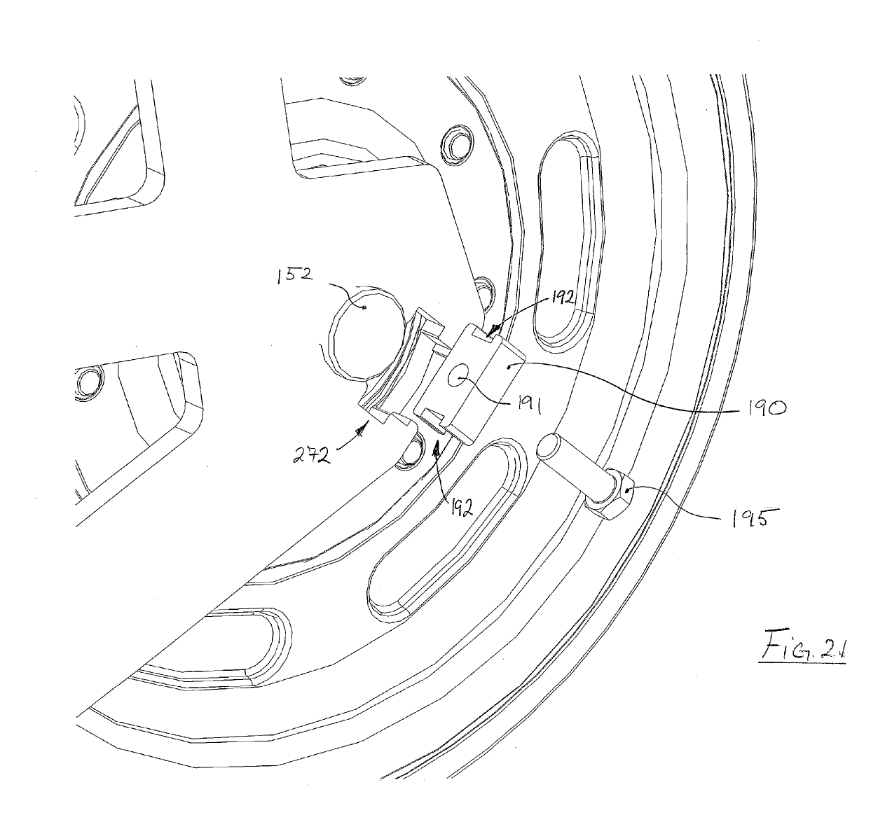

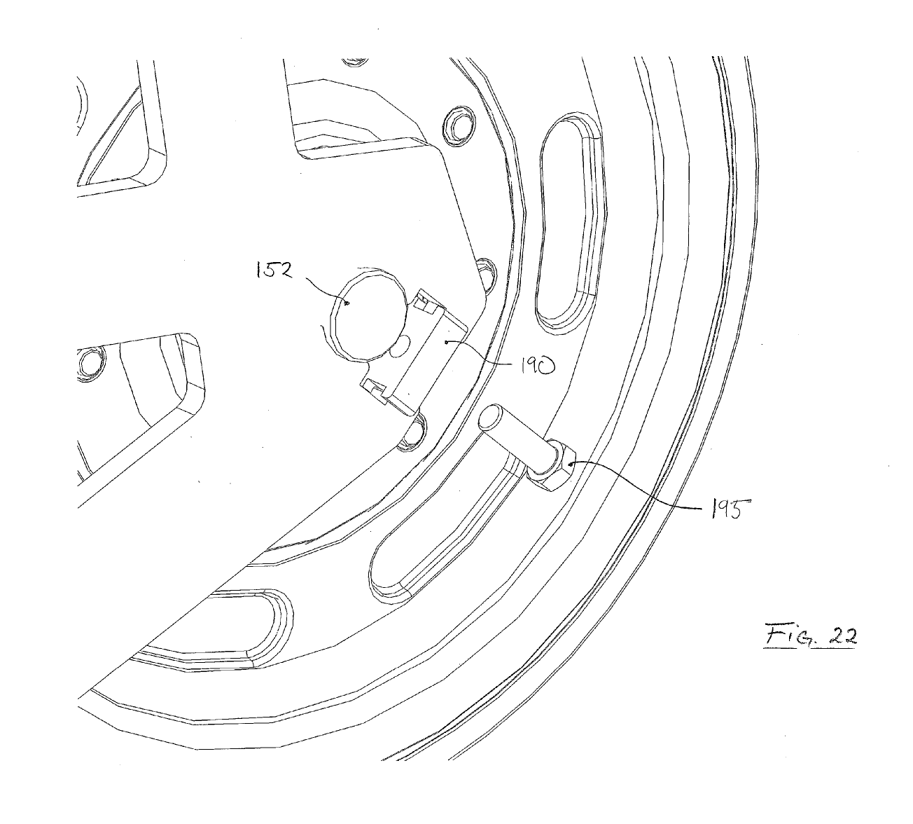

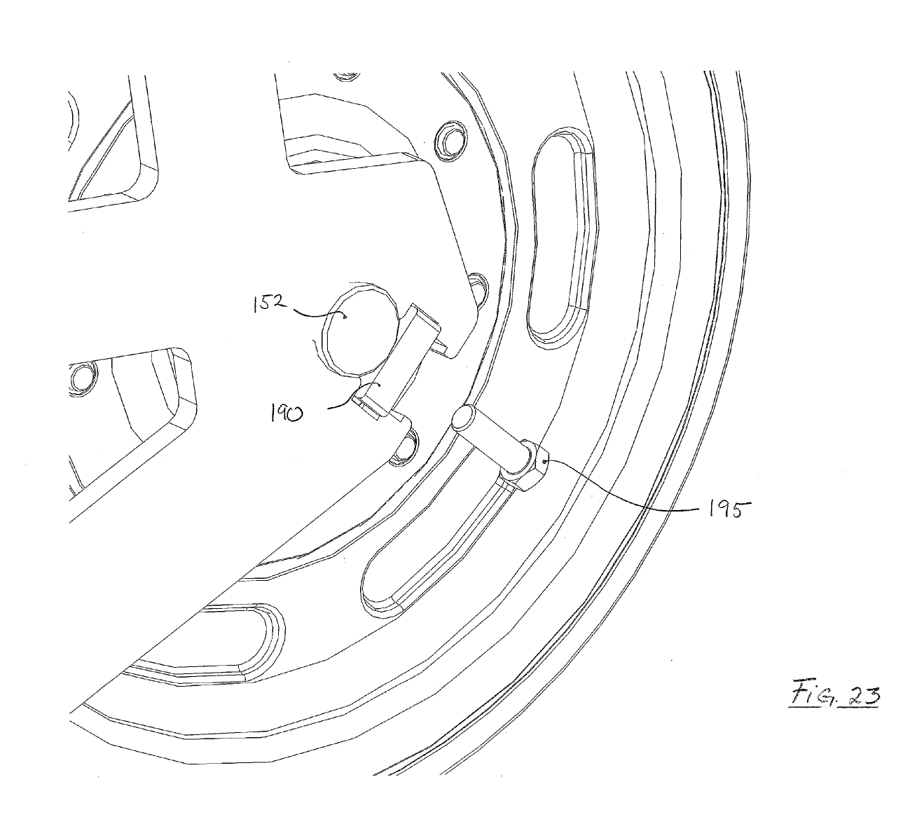

As shown in FIGS. 21 and 22, the locking element 190 is generally inserted laterally in the receiving area 270 via the slightly larger channel portions 272 provided thereto. When the locking element 190 is fully inserted into the receiving area 270, as shown in FIG. 23, the locking screw 195 is threaded into the threaded aperture 191 until it abuts on the axle 152. Once the locking screw 195 abuts on the axle 152, the locking screw 195 is further screwed in order to move the locking element 190 toward the shoulder portions 273 of the receiving area 270. In order to provide a secure arrangement therebetween, the locking element 190 is preferably provided with grooves 192 complementary with the shoulder portions 273.

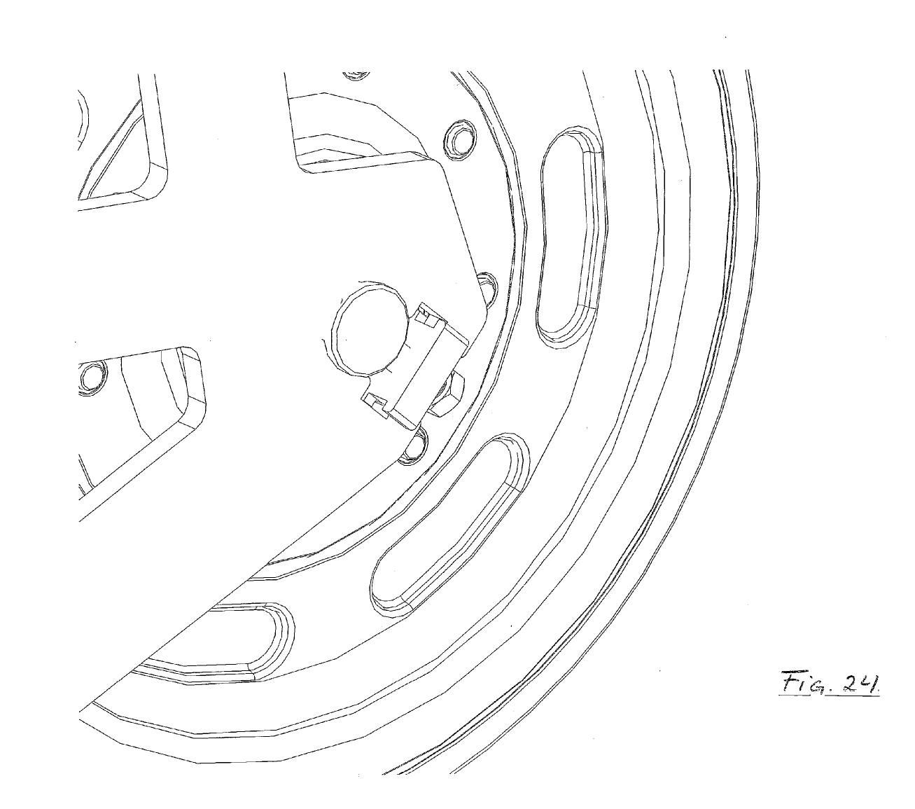

The complete installation is shown in FIG. 24 wherein the locking screw 195 abuts on the axle 152 and wherein the locking element 190 abuts on the shoulder portions 273.

To remove one row of wheels, either idler or road wheels, the steps of the foregoing process are effected in reverse.

As mentioned above, the wheels, either idler wheels 150 or road wheels 160, are mounted onto respective axle assemblies 250 or 260. Since, for all intent and purposes, axle assemblies 250 and 260 are substantially identical in nature, only axle assembly 250 shall therefore be further described. Still, it is to be understood that axle assembly 260 is of similar construction.

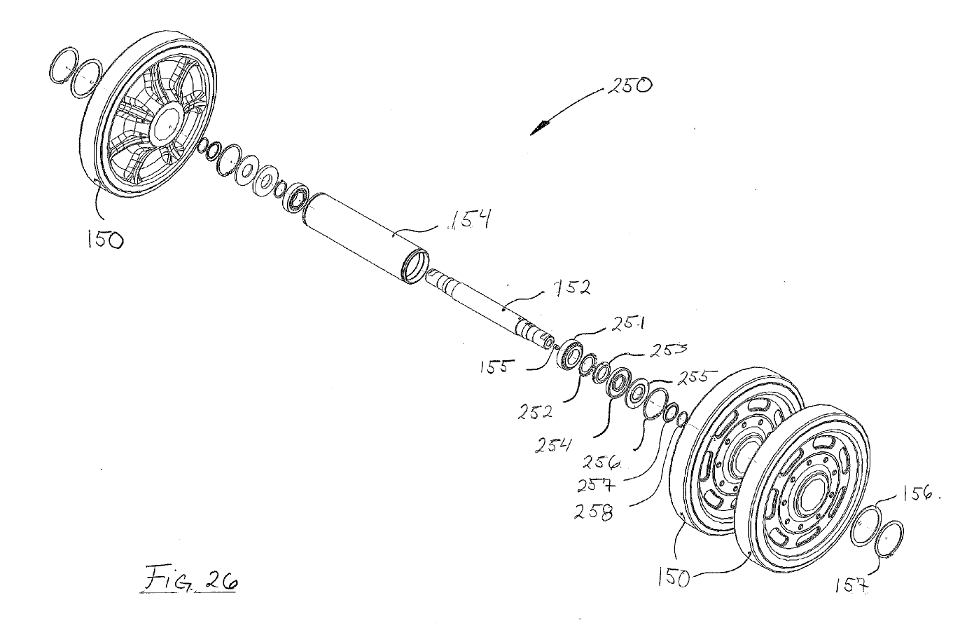

Referring first to the exploded view of FIG. 26, the axle assembly 250 generally comprises an outer tube 154 into which is pivotally mounted the axle 152. The pivotal movement of the outer tube 154 with respect to the axle 152 is provided by two bearing and seals assemblies mounted at each extremity of the axle 152. Understandably, the bearing and seals assemblies are symmetrical in nature.

Starting with the component nearest the axle 152, the bearing and seals assemblies generally comprise a tapered roller bearing 251, a lock washer 252, a nut 253, a radial seal 254, an axial seal ring washer 255, an internal snap ring 256, an axial seal 257 and an external snap ring 258.

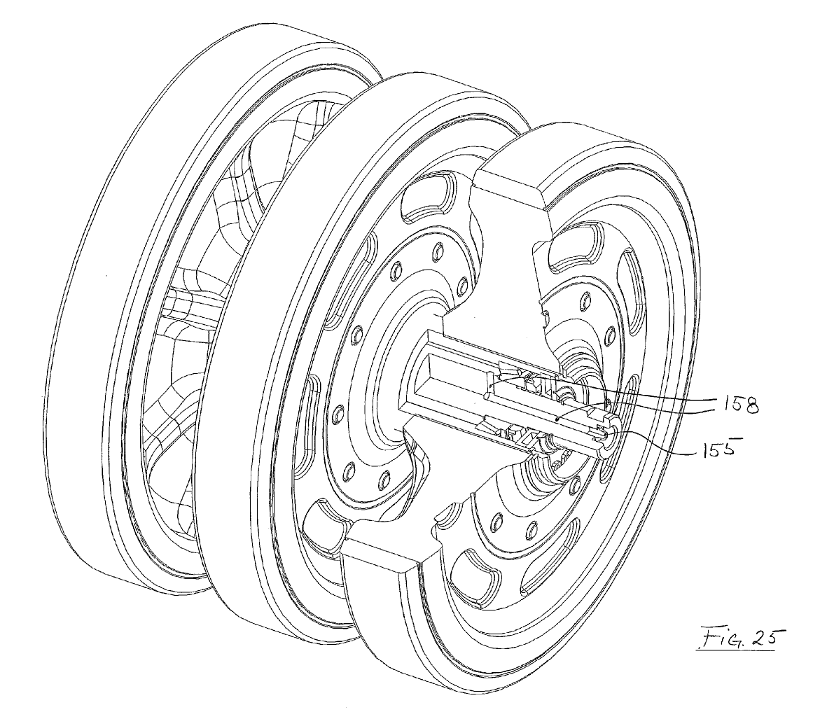

Once the axle 152 is mounted inside the outer tube 154 via the bearing and seals assemblies, the wheels 150 are press-fit on the outer tube 154 and secured in place via backing washer 156 and external snap ring 157 as shown in FIGS. 25 and 26.

One of the particularity of the axle assembly 250 of the present invention is that a cylindrical chamber is defined between the axle 152 and the outer tube 154 once the assembly 250 is fully assembled. This chamber is preferably filled with grease via a grease fitting 155 mounted at one extremity of the axle 152 and which is fluidly connected to the chamber via a duct 158 provided in the axle 152. By having an internal grease pressure higher than the ambient exterior pressure, the grease inside the axle assembly 250 will have a tendency to push outside any particles such as dust and/or sand that might enter the bearing and seals assemblies.

By preventing or at least reducing the entry of foreign particles in the bearing and seals assemblies of the axle assembly 250, the axle assembly 250 will be less prone to premature wear or even failure.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A traction assembly for use on a vehicle having a frame and at least one traction axle, said traction assembly comprising:
a. a sprocket wheel adapted to be fixedly mounted on said axle;
b. a support structure adapted to be pivotally mounted to said frame, said support structure further comprising:
c. a first portion comprising a first pivot point;
d. a second portion comprising a second pivot point;
e. at least one idler wheel pivotally mounted on said first portion of said support structure;
f. at least one idler wheel pivotally mounted on said second portion of said support structure;
g. a traction band tensioned around and cooperating with said sprocket wheel and said idler wheels;
wherein a first pivotal movement of said first portion or of said second portion induces a second pivotal movement of said second portion or of said first portion respectively, said second pivotal movement being in a direction opposite of said first pivotal movement.

2. A traction assembly as claimed in claim 1, wherein said first portion and said second portion are pivotally connected via a third pivot point.

3. A traction assembly as claimed in claim 1, wherein said support structure is adapted to be mounted near said traction axle.

4. A traction assembly as claimed in claim 1, wherein said first pivot point is located under said axle and longitudinally displaced with respect to said axle.

5. A traction assembly as claimed in claim 1, wherein said second pivot point is located under said axle and longitudinally displaced with respect to said axle.

6. A traction assembly as claimed in claim 1, wherein said first portion further pivotally supports at least one road wheel.

7. A traction assembly as claimed in claim 1, wherein said second portion further pivotally supports at least one road wheel.

8. A traction assembly as claimed in claim 1, wherein said first portion comprises a plurality of generally parallel idler wheels arranged widthwise.

9. A traction assembly as claimed in claim 1, wherein said second portion comprises a plurality of generally parallel idler wheels arranged widthwise.

10. A traction assembly as claimed in claim 1, wherein said first portion and said second portion comprise a plurality of generally parallel idler wheels arranged widthwise.

11. A traction assembly as claimed in claim 1, wherein said first portion further comprises a idler wheels tensioning system.

12. A traction assembly as claimed in claim 1, wherein said second portion further comprises a idler wheels tensioning system.

13. A traction assembly as claimed in claim 1, wherein said traction band is made of elastomeric material.

14. A traction assembly for use on a vehicle having a frame and at least one traction axle, said traction assembly comprising:
a. a sprocket wheel adapted to be fixedly mounted on said axle;
b. a support structure adapted to be pivotally mounted to said frame, said support structure further comprising:
c. a first portion comprising a first pivot point;
d. a second portion comprising a second pivot point;
e. at least one idler wheel pivotally mounted on said first portion of said support structure;
f. at least one idler wheel pivotally mounted on said second portion of said support structure;
g. a least one road wheel pivotally mounted on said first portion of said support structure and located at a first distance from said at least one idler wheel mounted on said first portion;
h. a least one road wheel pivotally mounted on said second portion of said support structure and located at a second distance from said at least one idler wheel mounted on said second portion;
i. a traction band tensioned around and cooperating with said sprocket wheel, said idler wheels and said road wheels;
wherein said first distance remains the same when said first portion pivots and
wherein said second distance remains the same when said second portion pivots.

15. A traction assembly for use on a vehicle having a frame and at least one traction axle, said traction assembly comprising:
a. a sprocket wheel adapted to be fixedly mounted on said axle;
b. a longitudinally extending support structure adapted to be mounted to said frame, said support structure having a front portion and a rear section;
c. a set of idler wheels pivotally mounted on said front portion of said support structure;
d. a set of idler wheels pivotally mounted on said rear portion of said support structure;
e. at least one set of road wheels pivotally mounted on said support structure;
f. a traction band mounted around and cooperating with said sprocket wheel, said idler wheels and said road wheels;
g. at least one laterally extending member mounted to said structure and disposed near the outer periphery of said wheels from one of said sets;
whereby said member reduce the accumulation of debris on said outer periphery.

16. A traction assembly as claimed in claim 15, wherein said assembly comprises a plurality of laterally extending members, each of said members being disposed near the outer periphery of said wheels from said sets of idlers or road wheels.

17. A wheel axle assembly adapted to be used on a traction assembly, said wheel assembly comprising:
a. an outer tube;
b. a shaft insertable in said tube;
c. first and second bearings, said first and second bearing being montable at each extremity of said shaft;
d. first and second sealing assemblies, said first and second sealing assemblies being montable at each extremity of said shaft and adjacent to said first and second bearings respectively;
e. a plurality of wheels fixedly mounted on said outer tube;
wherein when said shaft is mounted into said tube via said bearings and said sealing assemblies, said shaft and said tube define an inner chamber;
wherein said shaft comprises an inlet fluidly connected to said chamber via a duct; and,
wherein said chamber is adapted to receive lubricating fluid.

18. A shaft locking device for locking a shaft to a frame, said frame comprising at least one U-shaped shaft receiving recess adapted to receive said shaft, said device comprising a H-shaped shaft locking element having a threaded aperture therethrough for receiving a locking bolt, said H-shaped shaft locking element being adapted to fixedly engage said U-shaped shaft receiving recess whereby said locking bolt can be screwed to abut on said shaft.
